(19) United States
(12) Patent Application Publication
(10) Pub. No.: US 2025/0131910 A1
(43) Pub. Date: Apr. 24, 2025

(54) AUTOMATED PREDICTION OF PRONUNCIATION OF TEXT ENTITIES BASED ON CO-EMITTED SPEECH RECOGNITION PREDICTIONS

(71) Applicant: GOOGLE LLC, Mountain View, CA (US)

(72) Inventors: Leonid VELIKOVICH, New York, NY (US); Ágoston WEISZ, Pfaeffikon (CH)

(73) Assignee: GOOGLE LLC, Mountain View, CA (US)

(21) Appl. No.: 18/493,365

(22) Filed: Oct. 24, 2023

(51) Int. Cl. G10L 13/08

(52) U.S. Cl. CPC G10L 13/08

(57) ABSTRACT

A method, device, and computer-readable storage medium for predicting pronunciation of a text sample, including generating an encoding of allowable pronunciations of the text sample, selecting predicted text samples corresponding to an audio sample, the predicted text samples including the text sample and one or more co-emitted text samples, outputting the text sample, and updating the encoding of allowable pronunciations of the text sample based on pronunciations of the one or more co-emitted text samples.

### BACKGROUND

### Field of the Disclosure

The present disclosure relates to encoding and predicting pronunciations of text entities.

### Description of the Related Art

Automatic Speech Recognition (ASR) is a field of technology enabling electronic devices and systems to process an inputted audio sample or signal, the audio sample including spoken language. ASR can include, for example, a determination of a text representation of spoken language. The text representation can then be processed for meaning using natural language processing (NLP) systems.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction and are not intended to limit the scope of the following claims. The described embodiments, together with further advantages, will be best understood by reference to the following detailed description taken in conjunction with the accompanying drawings.

In one embodiment, the present disclosure is related to a method for predicting pronunciation of a text sample, comprising generating, via processing circuitry, an encoding of allowable pronunciations of the text sample; selecting, via the processing circuitry, predicted text samples corresponding to an audio sample, the predicted text samples including the text sample and one or more co-emitted text samples; outputting, via the processing circuitry, the text sample; and updating, via the processing circuitry, the encoding of allowable pronunciations of the text sample based on pronunciations of the one or more co-emitted text samples.

In one embodiment, the present disclosure is related to a device comprising processing circuitry configured to generate an encoding of allowable pronunciations of a text sample, select predicted text samples corresponding to an audio sample, the predicted text samples including the text sample and one or more co-emitted text samples, output the text sample, and update the encoding of allowable pronunciations of the text sample based on pronunciations of the one or more co-emitted text samples.

In one embodiment, the present disclosure is related to a non-transitory computer-readable storage medium for storing computer-readable instructions that, when executed by a computer, cause the computer to perform a method, the method comprising: generating an encoding of allowable pronunciations of a text sample; selecting predicted text samples corresponding to an audio sample, the predicted text samples including the text sample and one or more co-emitted text samples; outputting the text sample; and updating the encoding of allowable pronunciations of the text sample based on pronunciations of the one or more co-emitted text samples.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a method for updating a pronunciation model of a text entity, according to an embodiment of the present disclosure;

FIG. 2 is a schematic of a user device for performing a method, according to an embodiment of the present disclosure;

FIG. 3 is a schematic of a hardware system for performing a method, according to an embodiment of the present disclosure; and

FIG. 4 is a schematic of a hardware configuration of a device for performing a method, according to an embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

Mapping a text entity to a predicted pronunciation can enable an electronic device to accurately recognize and match a spoken text entity using ASR. The text entity can be any grouping of letters, including a grapheme, a syllable, a word, a name, or a phrase. In order to convert speech to text, a device can first determine a mapping of a word, phrase, or name to a pronunciation. The pronunciation can include a phonetic representation. In one embodiment, the mapping of the text entity to a pronunciation, as used herein, can include mapping the text entity to an intermediate form such as a neural embedding, wherein the neural embedding can be used for ASR and/or pronunciation prediction. For example, the neural embedding of a text entity can be an intermediate form that can be used by, or encoded in, an ASR model (e.g., an end-to-end speech recognition model) in addition to or in place of the original text entity. In one example, the intermediate form can be used in a language learning model (LLM) for speech recognition, such as through hypothesis spelling correction and rewriting.

The determination of pronunciation of text entities can enable the device to convert an incoming audio sample into a text transcription in a speech-to-text conversion. In instances where a pronunciation of a text entity is unknown, a device can predict the pronunciation based on prior pronunciation data, context, and phonetic rules. However, an initial prediction may not be accurate, especially when the text entity is a named entity (e.g., proper noun), is in a different language than a typical language used by the device, or is not a known word or name. There is a large amount of variability in human speech, and ASR systems often have to update and correct predicted pronunciation in order to accurately process an audio input. In one embodiment, the present disclosure provides systems and methods for refining a set of allowable pronunciations for a text entity based on ASR determination of similar text entities.

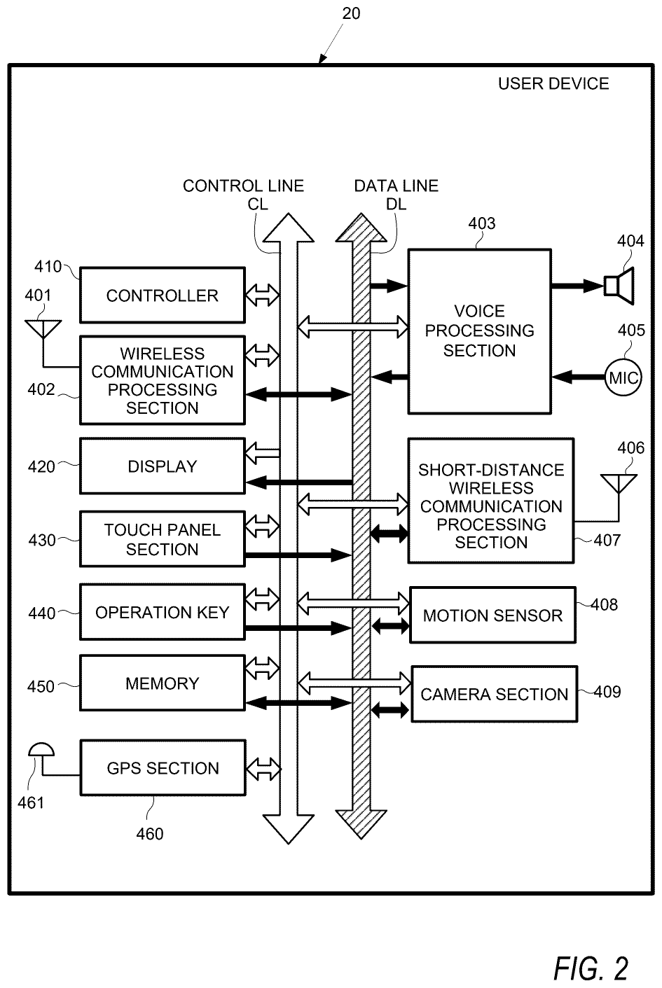

In one embodiment, a device can use ASR to process a speech request in an audio sample. The speech request can include, for example, a command or a question that is spoken by a human or a non-human system. The device can be an electronic device including, but not limited to, a mobile device (phone), a computer or tablet, or a wearable device. In one embodiment, the electronic device can be a consumer device, such as a television or vehicle, or an appliance such as a smart speaker or screen that can be configured for audio (voice)-activated functions. In one embodiment, the device as referred to herein can be a networked electronic device, such as a computer or a server, that can perform ASR functions for client devices (second devices). A client device can be an electronic device that records or receives an inputted audio sample, such as a mobile device, a wearable device, a consumer device, an appliance, etc. The client device can transmit the audio sample to the networked device over a network connection, and the networked device can process the audio sample using the ASR techniques described in the present disclosure. The networked device can transmit an output to the client device in response to the audio sample. The output can include a transcription of the audio sample or a data intermediate that can be used to process and respond to the audio sample. Examples of the electronic devices, including networked devices, and client devices, can include the hardware devices described herein with reference to FIG. 2 through FIG. 4 or any of the components thereof. Each of the electronic devices can include processing circuits/processing circuitry, the processing circuitry including one or more of: processors, controllers, programmed processing units (e.g., central processing units (CPUs)), integrated circuits, etc. Examples of processing circuitry and components thereof are further described herein with reference to FIGS. 2-4. The processes and methods described herein can be executed by processing circuitry in the described devices, e.g., by a CPU or a controller (or other circuitry) of an electronic device.

In one embodiment, a device can be configured for ASR in a manner that is customized to a user of the device. For example, the device can be a personal mobile device that is regularly and exclusively used by a single user. The user of the device can have unique modes of speech and/or qualities of speech. The device can use prior speech input from the user to update ASR functions in order to process new speech from the user. The speech recognition and pronunciation prediction of the device can conform specifically to the speech of the user for improved accuracy. In one embodiment, a device can be used by more than one user. In one embodiment, a user can be associated with a user profile, wherein the device can store or access the user profile in order to process an inputted audio sample. In one embodiment, the device can select a user profile based on the audio sample. For example, the device can perform voice recognition to identify a user and select a corresponding user profile. In one embodiment, the device can receive an input, such as a selection of a user profile, indicating a user of the device. The device can process the audio sample based on the selected user profile.

A single text entity can correspond to one or more allowable and plausible pronunciations. In addition, factors such as audio quality, speed of speech, and syntactic context (e.g., the spoken words surrounding the text entity) can affect the pronunciation of a text entity in an audio sample. It can therefore be necessary for a device to generate a pronunciation model for a text entity, wherein the pronunciation model can include a number of pronunciations for a single text entity. The pronunciations can include pronunciations derived from speech samples that were previously recorded and predicted pronunciations. The pronunciation model can include a mapping or encoding of the text entity to one or more pronunciations. A pronunciation associated with a text entity (e.g., in a pronunciation model of the text entity) can be referred to herein as an allowable pronunciation. The allowable pronunciations in the pronunciation model can include both likely and unlikely pronunciations, and the encoding of each pronunciation can indicate a predicted accuracy or likelihood of the pronunciation being correct. In one embodiment, the encoding of a pronunciation in a pronunciation model can be based on a measure of similarity between a first pronunciation and a second pronunciation. For example, the first pronunciation can be a likely pronunciation and the second pronunciation can be an unlikely pronunciation.

In one embodiment, pronunciations in the pronunciation model can include pronunciations of the text entity as well as pronunciations of other (reference) text entities, which can be referred to herein as reference pronunciations. The reference text entities can be similar to the text entity of the pronunciation model. For example, the reference text entities can share letters, syllables, or graphemes in common with the text entity. In one embodiment, the reference pronunciations can be similar to the predicted pronunciations of the text entity. For example, the pronunciations can share syllables or phonemes. The reference pronunciations can be unlikely pronunciations of the text entity but can be included in the pronunciation model to indicate the limits of allowable pronunciations. In one embodiment, the reference pronunciations can be pronunciations that can correspond to more than one text entity. For example, a reference pronunciation can be a pronunciation of a homophone with the text entity. In one embodiment, the pronunciation model can include a predictive model configured to generate possible pronunciations of the text entity. The device can determine whether an inputted sound matches a pronunciation in the pronunciation model of a text entity for speech recognition.

In one embodiment, the allowable pronunciations in the pronunciation model can be arranged in a list, cache, or similar data structure. In one embodiment, the pronunciations in a pronunciation model for a text entity can be encoded in a phoneme space, wherein a position of pronunciations in the phoneme space can correspond to a confidence or a predicted accuracy of each pronunciation for a given text entity. In one embodiment, the position of pronunciations in the phoneme space can correspond to acoustic features of the pronunciation. For example, pronunciations that are similar to each other can be encoded within a certain distance of each other in the phoneme space. The phoneme space can be an example of an encoding of the allowable pronunciations in the pronunciation model. In one example, the confidence can be based on a phonetic fit or an acoustic score of the pronunciation. The phoneme space can be modeled in two dimensions or can have more than two dimensions. In one embodiment, the boundary of the phoneme space can form a convex hull enclosing a locus of likely pronunciations associated with the text entity. In one embodiment, the boundary of the phoneme space can be formed by pronunciations, such as the reference pronunciations, that are known to be unlikely pronunciations but that are similar to the predicted pronunciations according to a metric of similarity or accuracy. The metric of similarity can include, for example, a proximity in a grapheme or phoneme mapping space. In one embodiment, the metric of similarity can be determined by an embedding of graphemes or phonemes. The embedding can be, for example, a neural embedding of graphemes or phonemes. Thus, pronunciations that deviate from the correct pronunciations can be excluded from the enclosed space of likely pronunciations. The inclusion of the similar reference pronunciations in the phoneme space can impose limitations on possible pronunciations of the text entity and can enable the device to distinguish between correct and incorrect, or likely and unlikely, pronunciations. For example, a pronunciation that is very similar to the reference pronunciation may be unlikely, as it is more likely to correspond to the reference text entity.

In one embodiment, the device can generate and update a pronunciation model for a text entity based on prior audio samples that have been received and used in speech recognition tasks. For example, a device can generate a pronunciation model for a text entity and can update the pronunciation model to include a pronunciation from an audio sample when the text entity is identified in the audio sample. Pronunciation of the same text entity can vary among different audio samples. In addition, the certainty of speech recognition can vary for each audio sample. Each audio sample can provide additional pronunciation data that can be used to refine the phoneme space of the text entity. In one embodiment, the device can encode an audio sample as a pronunciation of a text entity. The audio samples can be stored (e.g., cached) locally or remotely. The device can then use the prior audio samples (encoded pronunciations) corresponding to a text entity to generate and update a pronunciation model for the text entity. As the device receives more audio samples, the device can also modify prior encoded pronunciations based on new pronunciation data. The prior audio samples can include audio samples wherein the text entity has been positively identified with a high certainty, as well as audio samples wherein the text entity is identified with a low certainty.

In one embodiment, the device can generate a posterior distribution of pronunciations of a text entity in order to generate the pronunciation model. The posterior distribution can include the likelihood of one or more pronunciations of the text entity based on prior audio samples. The device can update the posterior distribution as new pronunciation data (e.g., audio samples) are received. The device can use the posterior distribution to compute a posterior likelihood of a given pronunciation for a given user. In one embodiment, the device can determine a most likely pronunciation based on the posterior distribution. For example, the device can use maximum likelihood estimation (MLE) or maximum a posteriori estimation (MAP) over possible pronunciations of a text entity to determine a most likely pronunciation with respect to the pronunciations of prior audio samples. The most likely pronunciation can be a pronunciation from a prior audio sample or can be a new pronunciation that is generated by a prediction model. The device can test and refine the pronunciation model using the prior audio samples.

In one embodiment, the device can use a prediction model to generate or predict pronunciations to populate the phoneme space based on the pronunciation model. In one embodiment, the prediction model can be a machine learning model and can include sequence-to-sequence model architecture, such as a recurring neural network (RNN) and/or a long short-term memory (LSTM) architecture, to transform a text sequence to a speech sequence. In one embodiment, the prediction model can include a grapheme-to-phoneme (G2P) model to predict a pronunciation of a text entity. The G2P model can use phonetic rules and/or a phonetic dictionary to predict the pronunciation of the text entity. In one embodiment, the G2P model can use one or more phoneme spaces to predict a pronunciation of a text entity. For example, the device can input one or more reference pronunciations for different text entities that are similar to but not acceptable as potential pronunciations for the text entity to the G2P model. The reference pronunciations can be, for example, incorrect pronunciations that were previously proposed by the device and corrected. In one embodiment, the reference pronunciations can be selected based on at least one metric of similarity. The metric of similarity can be a similarity between the text entities or between the pronunciations. The G2P model can use the reference pronunciations as limitations when predicting a pronunciation of the text entity. For example, a predicted pronunciation can differ from a reference pronunciation in one or more phonemes so as not to be identical to a reference pronunciation. In one embodiment, the device can arrange the pronunciations in the phoneme space based on the reference pronunciations that were input to the G2P model. For example, the proximity between a predicted pronunciation and a reference pronunciation in the phoneme space can depend on whether the reference pronunciation was used in the prediction by the G2P model.

In one embodiment, the predictive model can use zero-shot learning methods to predict the pronunciation of the text entity. Zero-shot learning can refer to a model (e.g., a G2P model) predicting a pronunciation for a text entity (e.g., a grapheme, previously unseen word) that was not explicitly observed in training of the model. In one embodiment, a predictive model can use auxiliary information, such as phonetic rules for a certain language, to predict a pronunciation for a text entity. For example, the device can input the text entity to a G2P model. The G2P model can determine that the text entity is a common name in a language based on information such as the spelling of the name. The G2P model can then predict a pronunciation of the name according to the language of the name. The device can use the G2P model to predict one or more pronunciations and can add the output pronunciations to the phoneme space. In one embodiment, the G2P model can output a confidence corresponding to a predicted pronunciation. The device can arrange the predicted pronunciation in the phoneme space based on the confidence.

In one embodiment, the device can update the encoding of the pronunciation model for a text entity based on prior audio samples corresponding to the text entity. For example, the device can assign a rank or score to allowable pronunciations for a text entity, wherein the allowable pronunciations are based on prior audio samples corresponding to the text entity. The device can modify the encoding of the pronunciation model of the text entity based on prior audio samples, e.g., by updating a confidence or likelihood of a pronunciation based on a similarity to pronunciations in prior audio samples. In one embodiment, the device can train or retrain a pronunciation prediction model using the prior audio samples. In one embodiment, the device can run (or rerun) an ASR process, such as decoding an audio sample to determine a text entity corresponding to the audio sample, based on received audio samples. In one example, the device can constrain an ASR decoder to predict a limited set of text entities. The re-decoding of the prior audio samples can include recalculating a likelihood or certainty for each pronunciation. In one example, the device can determine a speech-text alignment by implementing a time constraint on decoded transcripts, the time constraint being based on prior audio samples. The emitted transcript should fit within the time boundaries of the audio sample. In one embodiment, the device can train an ASR recognizer to emit phoneme sequences corresponding to an audio sample. The phoneme sequences can be emitted to in place of or in combination with words. In one embodiment, the device can train an ASR recognizer to emit phoneme sequences corresponding to a prior audio sample, wherein the prior audio sample has been encoded as a pronunciation of a text entity of interest. The generation of phoneme sequences can be used to identify phonemes corresponding to the text entity. The device can then use the phonemes of the phoneme sequence to predict a new pronunciation of the text entity. The new pronunciation can be based on one or more phonemes of the phoneme sequence and can be determined independently of pronunciations of other text entities (e.g., reference pronunciations). The device can thus generate new pronunciations without relying on existing pronunciations associated with the text entity or any pronunciations of existing words. In one embodiment, the device can use the ASR recognizer on more than one audio sample in order to minimize variation/noise between audio samples, as a phoneme sequence can be more variable than known word sequences.

In one embodiment, the device can determine a level of confidence (or uncertainty) in pronunciation of a new text entity in response to receiving or accessing the new text entity for the first time. In one embodiment, the device can determine the level of confidence for a text entity based on how common the text entity is. In one embodiment, the device can predict one or more allowable pronunciations of the text entity and can determine a measure (level) of confidence for pronunciation of the text entity based on the predicted pronunciations. For example, the level of confidence can be based on whether the predicted pronunciation of the text entity conforms to certain phonetic rules. The measure of confidence can be associated with individual predicted pronunciations of the text entity or can be an aggregate measure for the text entity. In one embodiment, the device can access pronunciation data related to the text entity in order to determine the level of confidence in pronunciation of the text entity. For example, the device can access an online dictionary to retrieve allowable pronunciations of the text entity and/or a level of certainty in the pronunciation. In one embodiment, the device can access pronunciation data from a database of ASR tasks to determine the level of confidence. In one example, a commonly used text entity (e.g., a name) in the language of the device operating system can be associated with a high measure of confidence. The device can generate, access, or retrieve allowable pronunciations of the commonly used text entity that have been confirmed to be accurate in prior ASR tasks. Text entities that are not common or that are not known words can be associated with a low measure of confidence. The device can generate, access, or retrieve allowable pronunciations of the text entity, but there may not be enough pronunciation data to confirm the accuracy of the allowable pronunciations.

In one embodiment, the device can generate a pronunciation model for a new text entity based on the level of uncertainty for the pronunciation. The device can generate the pronunciation model in response to receiving the new text entity. For example, the device can generate a pronunciation model for a contact name in response to the contact being created. In one example, the device can generate a pronunciation model for a text entity that is inputted into the device, e.g., as a keyboard input. It can be useful for the device to “overgenerate” pronunciations for text entities with low confidence in order to avoid excluding potential allowable pronunciations. According to one embodiment, overgenerating pronunciations can refer to including more allowable pronunciations in the pronunciation model than would be included for a text entity with a lower level of uncertainty. In one embodiment, the device can include pronunciations with low or unknown predicted accuracy in the pronunciation model for a text entity with high uncertainty. In one embodiment, the device can generate a phoneme lattice representing a probability distribution over phonemes in the text entity. The device can use the phoneme lattice to determine at least a partially correct pronunciation of the text entity. For example, the pronunciation of certain graphemes or subgroupings of letters in the text entity can be predicted with a higher accuracy than other graphemes based on linguistic rules. In one embodiment, the device can access foreign or cross-lingual sources to generate the phoneme space for the text entity. In one embodiment, the device can access external data sources, such as a web-based database, to mine allowable pronunciations of the text entity. It can be helpful to overgenerate pronunciations when there is limited pronunciation data available for the text entity. The larger phoneme space can then be refined over time via ASR tasks to remove unlikely pronunciations.

In one embodiment, the device can use prior audio samples (e.g., audio samples from prior ASR tasks) to update a pronunciation model. Using prior audio samples to update the pronunciation model can improve the likelihood of correctly predicting a pronunciation because the audio samples can include pronunciations in varying contexts. As an example, an audio sample can include a pronunciation of a text entity that is decoded with high certainty. The high certainty can be due to the decoded text entity being positively confirmed via an input to the device. In one embodiment, the high certainty can be based on the context of the audio sample. For example, the device can use the context of the audio sample to constrain the types of text entity (e.g., contact names) that are predicted based on the audio sample. The high-certainty pronunciation can be used to analyze new audio samples that may lack context or confirmation. When receiving a subsequent audio sample, the device can decode the audio sample to predict a text entity by comparing an acoustic score of the new audio sample with an acoustic score of a prior audio sample that was decoded with high certainty. For example, if the pronunciation in the subsequent audio sample matches the pronunciation of the prior audio sample, the device can assign a high acoustic score to the pronunciation in the subsequent audio sample regardless of the context of the audio sample. The device can also use pronunciations from prior audio samples with low certainty to update a pronunciation model and/or as a reference pronunciation for assessing a new audio sample.

The device can update pronunciation models at any point after an audio sample is received or recorded. For example, the device can receive and process an audio sample and can update the pronunciation model for a text entity corresponding to the audio sample at a later time. In one embodiment, the device can update a pronunciation model in a background thread and/or while performing other tasks. The device can update the pronunciation model locally or can transmit the prior audio samples to a networked device for processing. The networked device can receive audio samples from one or more client devices corresponding to one or more users and can update a pronunciation model for a text entity based on the audio samples from the one or more client devices. The device can then use an updated pronunciation model and aggregate knowledge of prior audio samples to improve accuracy of pronunciation predictions for a text entity.

In one embodiment, the device can update the pronunciation model for a text entity when the text entity is predicted during an ASR task. A device can use ASR techniques to decode an audio sample and predict one or more text entities corresponding to the audio sample. The prediction of the one or more text entities can be based on a pronunciation model for each of the one or more text entities. For example, when a pronunciation in an audio sample matches an allowable pronunciation of a text entity, the device can include the text entity in a list of predicted text entities corresponding to the audio sample. The one or more predicted text entities can be selected by the device based on a similarity between the audio sample and an allowable pronunciation of the one or more predicted text entities. The similarity can be based on a quantifiable metric, such as acoustic scores of the audio sample and/or the allowable pronunciation.

In one embodiment, the device can predict more than one text entity as corresponding to an audio sample. In one embodiment, the one or more predicted text entities can be encoded as an ASR lattice of predictions. A lattice can be an n-best list of predictions, wherein n can be an integer. An ASR lattice can form a compact representation of multiple (parallel) hypotheses generated by an ASR system. The ASR lattice can be a rich output of an ASR system. In one embodiment, the device can only output a single prediction from the lattice of one or more predicted text entities. The single prediction can be referred to herein as an outputted text entity. The one or more predicted text entities from the lattice that are not outputted can be referred to herein as co-emitted text entities. Co-emitted text entities can be alternative words or phrases and can also include subword lattices (e.g., combinations of words and subword text entities). In one embodiment, the selection of the outputted text entity rather than the co-emitted text entities can be based on an acoustic score or similarity between the audio sample and a pronunciation of the outputted text entity. In one embodiment, the selection of the outputted text entity can be based on syntactic context.

In one embodiment, the device can use surrounding syntactic context of an audio sample to select a predicted text entity corresponding to the audio sample in an ASR task. For example, a speech request can include a command to initiate communication with a contact stored in the device's digital address book. The device can identify command words related to initiating communication, such as to “call” or “send a message.” The device can then determine that there is an increased probability that subsequent or surrounding words in the speech request can correspond to pronunciation of a name of a contact stored in the device's digital address book. The device can use pronunciation models corresponding to contact names to select the contact named in the speech request. In one example, a speech request can include a command to initiate navigation to a location. The device can identify command words relating to navigation, such as to “map” or “start a route” to a location. The device can then determine that there is an increased probability that subsequent or surrounding words in the speech request can correspond to pronunciation of a location. The location can be, for example, a named geographical location or an address associated with a contact in the device's digital address book. The device can use pronunciation models corresponding to geographical locations to select a location as a text entity. In one embodiment, the syntactic context of the audio sample can bias the selection of a predicted text entity. In one embodiment, the syntactic context can be given a heavier weight than acoustic factors or phoneme space encoding in the selection of the outputted text entity.

In one embodiment, the device can output the text entity as a displayed output or an audio output. For example, the device can receive a speech request to send a message to a contact stored in the device's digital address book. The device can decode the speech request to identify the contact name and can display a confirmation prompt asking if the user intends to send the message to a contact name, the contact name being the outputted text entity. In one embodiment, outputting a text entity can refer to the device taking an action or executing a process based on the audio sample and the outputted text entity. For example, the device can receive a speech request to call a contact stored in the device's digital address book. The device can decode the speech request to identify the contact name and can initiate a call to the contact. The device can predict more than one contact names (text entities) based on the speech request but can only make a call to a single contact whose name is one of the predicted contact names (text entities). In one example, the device can receive a speech request to run a search in a search engine for a named entity. The device can process (e.g., decode) the speech request to predict more than one text entities corresponding to the speech request but can only select one of the text entities from the more than one predicted text entities in order to output results from a search.

In one embodiment, the device can receive a confirmation in response to the outputted text entity indicating that the outputted text entity is an accurate decoding of the audio sample. The confirmation, as used herein, can include an action (input) or a lack of action (input) to the device. For example, when the device displays the outputted text entity in a confirmation prompt, the device can then receive a confirmation input via a user interface indicating that the outputted text entity is correct. In one example, the device can compose a text message to a contact based on a speech request, wherein the name of the contact and/or the content of the text message include the outputted text entity. When the outputted text entity is correct, the device can receive an instruction to send the text message as a confirmation input. In one example, the device can initiate a call to a contact based on a speech request, wherein the name of the contact is the outputted text entity. When the outputted text entity is correct, the user can allow the call to continue rather than ending the call or making additional speech requests. The lack of a correction action can be an implicit confirmation of the outputted text entity.

In one embodiment, the device can update the pronunciation model for the outputted text entity based on the audio sample and the remaining co-emitted text entities of the ASR lattice. For example, when the outputted text entity is correct, the device can update the pronunciation model for the outputted text entity to include a pronunciation from the audio sample as an allowable pronunciation. The device can update the encoding of allowable pronunciations based on an acoustic relationship (e.g., similarity) with the audio sample. In one embodiment, the device can further update the encoding of allowable pronunciations based on an acoustic relationship (e.g., similarity) with pronunciations corresponding to the co-emitted text entities. The pronunciations of one or more of the co-emitted text entities may or may not have been included in the pronunciation model of the outputted text entity prior to the prediction.

The device can improve the accuracy of the pronunciation model of the outputted text entity by updating the encoding of allowable pronunciations based on the pronunciations of the co-emitted text entities in addition to the audio sample. Pronunciations of the co-emitted text entities and the outputted text entity have a degree of similarity given that they were each selected by the device when decoding the audio sample. Each co-emitted text entity can correspond to a phonetic approximation of the outputted text entity. The co-emitted text entities can be considered unsurfaced misrecognitions when the outputted text entity is confirmed to be a correct text representation of the audio sample. The device can update the encoding of allowable pronunciations for the outputted text entity based on the fact that correct pronunciation(s) of the outputted text entity can be similar to or can overlap with pronunciations of one or more co-emitted text entities. In one embodiment, the device can update the pronunciation model of the outputted text entity by adding or labeling a pronunciation of a co-emitted text entity in the phoneme space. For example, the device can inject a co-emitted text entity into a pronunciation model of the outputted text entity and can determine a similarity between the pronunciation of the co-emitted text entity and other pronunciations in the phoneme space of the outputted text entity. In one example, the pronunciation of the co-emitted text entity can be labeled or otherwise identified in the phoneme space as being similar to a correct pronunciation of the outputted text entity. In one embodiment, the device can update the pronunciation model of the outputted text entity by including a pronunciation of a co-emitted text entity as a reference pronunciation in the phonetic space of the outputted text entity. For example, the pronunciations of co-emitted text entities can be used to form a boundary of allowable pronunciations of the outputted text entity.

In one embodiment, the device can update the pronunciation model of the outputted text entity by increasing the predicted accuracy of allowable pronunciations that are similar to pronunciations of one or more of the co-emitted text entities based on one or more acoustic features or metrics. In one embodiment, the device can update the pronunciation model of the outputted text entity by decreasing the predicted accuracy of allowable pronunciations that are dissimilar to one or more of the co-emitted text entities based on one or more acoustic features or metrics. For example, a similarity between an allowable pronunciation and a co-emitted text entity pronunciation can be based on whether the two pronunciations share a certain phoneme that is found in the outputted text entity pronunciation. In one example, the device can update the phoneme space of the outputted text entity to be more weighted towards pronunciations that are similar to those of the co-emitted text entities. For example, the device can increase the predicted accuracy associated with any pronunciations of the outputted text entity that have a certain metric of acoustic similarity with pronunciations of one or more co-emitted text entities.

In one embodiment, the device can update the pronunciation model of the outputted text entity by computing an area of intersection (e.g., a set) between the pronunciations of one or more co-emitted text entities and the pronunciation of the outputted text entity. In one embodiment, the device can update the pronunciation model based on the computed area of intersection. For example, the device can update the pronunciation model so that the phoneme space is more similar to the computed area of intersection. The computed area of intersection can be a loose set. In one embodiment, the device can encode the pronunciations of the one or more co-emitted text entities as a convex hull in a multidimensional phoneme space. The device can use the convex hull to refine allowable pronunciations of the outputted text entity towards the centroid of the convex hull. In one embodiment, the convex hull can represent a space of allowable pronunciations. Pronunciations that fall outside of the convex hull in the phoneme space can be removed from the pronunciation model of the outputted text entity. In one embodiment, the phoneme spaces can be generated and/or updated using a machine learning model. For example, the device can use a G2P model (e.g., a phoneme-to-phoneme sequence model) to refine allowable pronunciations of the outputted text entity using the pronunciations of one or more co-emitted text entities as inputs to the G2P model.

In one embodiment, the device can continuously update the pronunciation model for the outputted text entity based on co-emitted text entities in an iterative process. For example, whenever the outputted text entity is predicted in an ASR task, the device can update or include the phoneme space based on the co-emitted text entities in the ASR task. In this manner, the device can refine the phoneme space and can improve the accuracy of the allowable pronunciations based on new ASR tasks. For example, the phoneme space can be continuously narrowed based on the overlap between co-emitted text entities for each ASR task. The use of co-emitted text entities in refining the phoneme space can be especially helpful for named entities or outputted text entities without known pronunciation data. The co-emitted text entities can provide multiple points of pronunciation data for refining the phoneme space of the outputted text entity for each ASR task.

The device can update the pronunciation model for an outputted text entity based on co-emitted text entities when the outputted text entity is outputted based on syntactic context. For example, the audio sample can include syntactic context related to the name of a contact stored in the device's digital address book. The device can output a text entity from the digital address book rather than a text entity that is absent from the digital address book even if the pronunciation(s) of the text entity in the digital address book are associated with a low measure of certainty. The syntactic context can bias the selection of the text entity from the digital address book and can override an acoustic score or probabilistic measures of accuracy associated with allowable pronunciations of the outputted text entity and/or co-emitted text entities. The co-emitted text entities can still be predicted based on acoustic features and predicted accuracy corresponding to each co-emitted text entities' pronunciation model. In this manner, the device can use constraints imposed by syntactic context to output accurate ASR predictions of text entities with low pronunciation certainty while taking advantage of the rich output of pronunciation data provided by the co-emitted text entities to update the pronunciation model of the low-certainty outputted text entity.

In one embodiment, the device can retrieve co-emitted text entity data from external ASR data sources. For example, the device can access data from ASR tasks that were performed by other devices. The device can update the phoneme space of a text entity based on the co-emitted text entities of other devices. In one embodiment, the device can retrieve co-emitted text entity data from other ASR tasks in order to generate the pronunciation model for a text entity. The use of data from external devices and ASR history can provide a wider range of allowable pronunciations that can then be refined by the device based on its own ASR tasks.

In one example, the device can generate a pronunciation model for a first text entity. In order to generate allowable pronunciations, the device can retrieve or determine co-emitted text entities for the first text entity. In one embodiment, the device can retrieve or determine a second text entity, wherein the first text entity was a co-emitted text entity for the second text entity. The second text entity may or may not be a co-emitted text entity for the first text entity. The device can update the phoneme space of the first text entity based on the second text entity.

In one example, the device can output a text entity and can receive a correction input indicating that the outputted text entity is incorrect. The correction input can be input to the device via a user interface. For example, the correction input can be a second speech request. In one embodiment, the correction input can include an instruction to the device to execute a process or to stop executing a process. For example, a speech request can include a command to call a contact, and the device can initiate the call to a contact whose name was identified using ASR. When a device initiates a call to the wrong contact, a user can end the call rather than allowing the call to continue. The instruction to end the call can be a correction input that can be received by the device via a user interface and can indicate that the outputted text entity (the contact's name) was incorrect. In one example, the device can execute a process in response to decoding a speech request including an instruction. When the device has incorrectly decoded the speech request, the device can receive a subsequent instruction to undo the previously executed process. The subsequent instruction can be a correction input indicating that the decoding of the first speech request was incorrect, thus resulting in the device executing an unwanted process. In one embodiment, the device can update the pronunciation model for the incorrectly outputted text entity based on co-emitted text entities.

In one embodiment, the device can generate and update the pronunciation model for an outputted text entity based on co-emitted text entities even when the outputted text entity is incorrect. The co-emitted text entities can still have an acoustic similarity to the outputted text entity regardless of whether the outputted text entity is correct. Therefore, the device can still refine the pronunciation model of the outputted text entity based on the co-emitted text entities as has been described herein.

The systems and methods presented herein are compatible with anonymization and abstraction of data to preserve user privacy and protect user data. For example, a device (e.g., a user device) can store audio samples locally and/or can obscure data related to an audio sample before transmitting the audio sample to a networked device. In one embodiment, a device can store and use intermediate forms of audio data rather than raw waveforms. The intermediate forms can be transformations or encodings of raw audio samples, such as acoustic activations or probability distributions of acoustic frames. The intermediate forms can be used and processed by a neural model for ASR but does not contain sensitive or personal information that can be extracted. In addition, the updating of a pronunciation model in a background thread can enable a device to extract data, such as a phoneme space for a text entity, that is anonymized and does not include personal identifiers related to a user of the device. The device can then transmit the anonymized data to a networked device and/or use the anonymized data for later ASR without exposing the user's personal data or speech in future processing.

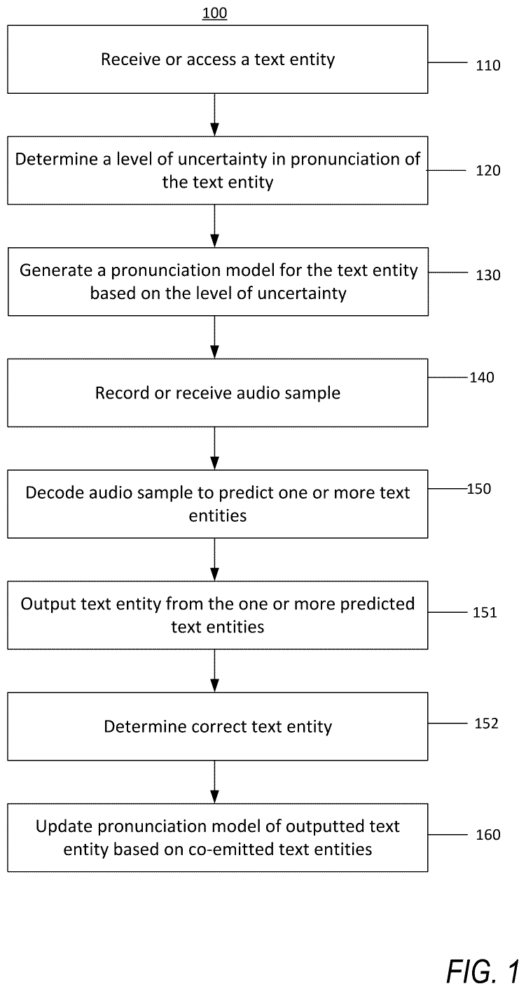

FIG. 1 is a flow chart illustrating a method 100 for updating a pronunciation model of a text entity, according to one embodiment of the present disclosure. The method can be performed by processing circuitry of an electronic device such as a mobile phone, a computer, an assistant device, or a server. In step 110, the device can receive or access a text entity. The text entity can be received by the device via a user interface. In one embodiment, the text entity can be transmitted to the device by a second electronic device. In step 120, the device can determine a level of uncertainty in pronunciation of the text entity. The device can determine the level of uncertainty based on how common the text entity is. In one embodiment, the device can determine the level of uncertainty based on available pronunciation data associated with the text entity. For example, the device can access existing pronunciation data and ASR data to determine whether there are known pronunciations of the text entity and a level of uncertainty associated with the known pronunciations. The existing pronunciation data and ASR data can be retrieved from a networked device, such as a server.

In step 130, the device can generate a pronunciation model for the text entity based on the level of uncertainty. The device can use a model to generate allowable pronunciations of the text entity and can encode the allowable pronunciations in a phoneme space. In one embodiment, the device can mine existing pronunciation data and ASR data to retrieve allowable pronunciations of the text entity. The device can overgenerate pronunciations based on the level of uncertainty associated with the text entity.

In step 140, the device can record or receive an audio sample including the text entity. The audio sample can be recorded by a microphone, the microphone being embedded in or connected to the device. The audio sample can include a speech request, such as a command or a question, made by a user. The speech request can be presented in natural language. In step 150, the device can process the audio sample using one or more speech recognition models or methods and generate one or more text entity predictions based on the audio sample. The one or more predicted text entities can include the text entity received in step 110 and one or more alternative text entities. In one embodiment, the device can predict each text entity based on the pronunciation model of the text entity and the audio sample. For example, the device can predict the text entity based on an acoustic similarity between one or more allowable pronunciations of the text entity and the pronunciation in the audio sample. In one embodiment, the device can predict the text entity based on syntactic context of the audio sample. For example, the syntactic context of the audio sample can indicate that the audio sample includes a certain type of text entity. The device can predict text entities of the certain type based on the syntactic context. In one embodiment, the device can weigh the syntactic context more than acoustic features of an allowable pronunciation in order to generate the text entity predictions.

In step 151, the device can output a text entity from the one or more predicted text entities. Outputting the text entity can include outputting the text entity via a user interface, such as a display screen or as a TTS audio sample. In one embodiment, the device can output the text entity by executing a process based on the text entity. In step 152, the device can determine whether the outputted text entity was correct. In one embodiment, the device can receive a confirmation or a correction in response to the outputted text entity. The confirmation can be an input or instruction indicating that the outputted text entity is an accurate decoding of the audio sample. In one embodiment, the confirmation can include a lack of input or instruction, e.g., allowing the executed process of step 151 to be completed. A correction can be an input or instruction indicating that the outputted text entity is not an accurate decoding of the audio sample. In one embodiment, the correction can include an instruction to stop the process of step 151.

In step 160, the device can update the pronunciation model of the outputted text entity based on the co-emitted text entities that were predicted in step 150 but not outputted. In one embodiment, the device can determine one or more pronunciations of each of the co-emitted text entities using the pronunciation model for each of the co-emitted text entities. In one embodiment, the device can select pronunciations for each of the co-emitted text entities based on a measure of similarity or commonality across pronunciations for each of the co-emitted text entities. For example, the device can select a pronunciation of a first co-emitted text entity that has an acoustic similarity to a pronunciation of a second co-emitted text entity.

In one embodiment, the device can update the pronunciation model of the outputted text entity by computing an intersection set (e.g., an area of intersection) comprising the pronunciations of the co-emitted text entities within the phoneme space of the outputted text entity. The intersection set can include pronunciations that are encoded within a set distance of the co-emitted text entity pronunciations within the phoneme space. The intersection set can exclude pronunciations that are encoded further than the set distance from the co-emitted text entity pronunciations within the phoneme space. In one example, the intersection set can be a convex hull in a multidimensional phoneme space. The device can refine the phoneme space based on the intersection set. For example, the device can remove pronunciations encoded outside of the intersection set. In one example, the device can refine pronunciations within the intersection set. In one embodiment, the device can update predicted accuracies of pronunciations encoded in the phoneme space based on the intersection set.

In one embodiment, the device can update the pronunciation model of the outputted text entity by generating new pronunciations of the outputted text entity based on the co-emitted text entities. In one example, the device can use a G2P model and can input pronunciations of the co-emitted text entities to the G2P model as phonetic approximations for the pronunciation of the outputted text entity. The device can encode the predicted pronunciations in the phoneme space of the outputted text entity. The device can repeat steps 140 through 160 when the text entity is predicted in subsequent ASR tasks in order to continue refining the pronunciation model for the text entity. In one embodiment, the device can update the pronunciation model in step 160 based on previous ASR tasks. For example, the intersection set of pronunciations can include co-emitted text entities from previous ASR tasks. The device can update the intersection set to include additional co-emitted text entities rather than creating a new intersection set each time that the text entity is outputted. The device can thus iteratively refine the phoneme space over time.

It can be appreciated that the method of FIG. 1 and the pronunciation models as presented herein can be integrated into other ASR models and speech processing functions. For example, the device can further encode and/or decode the audio sample. In one embodiment, the method of FIG. 1 can be distributed among more than one device. For example, a first device can be a mobile device configured to record an audio sample with a microphone and transmit the recorded audio sample to a second device over a communication network. The second device can be a server configured for ASR and can store or access pronunciation models associated with the first device. The second device can select an outputted text based on the received audio sample and can transmit the outputted text entity to the first device over the communication network. The first device can output the text entity and receive the confirmation/correction input. The first device can then transmit the confirmation/correction input to the second device. The second device can update the corresponding pronunciation model or models based on the confirmation/correction input.

In the following example, a device configured with a voice-activated assistant can use the methods presented herein to determine pronunciations of a foreign contact name. The device can be, for example, a mobile phone. The mobile phone can include a contact named “Xavier” stored in a digital address book. The mobile phone can determine a level of uncertainty for pronunciation of Xavier. In one embodiment, the mobile phone can determine the level of uncertainty based on how common the name is or available pronunciation data for the name. In the present example, the level of uncertainty can be high given that there are multiple pronunciations of Xavier in different languages.

The mobile phone can generate a pronunciation model for the contact name “Xavier” when the contact is added to the digital address book. The mobile phone can include allowable pronunciations for Xavier in the pronunciation model that are generated using language models (e.g., G2P models). For example, the “X” in Xavier can be pronounced as “ex”, as a “z,” or as an “h” in English romanization; the “a” in Xavier can be a long a or a short a; the “r” in Xavier can be pronounced or can be silent; the syllable emphasis can vary. Additional pronunciation may also be possible. The mobile phone can encode the pronunciations in a phoneme space. In one embodiment, the mobile phone can generate a level of confidence for each allowable pronunciation using the language models.

The voice-activated assistant of the mobile phone can be activated by a speech request by a user to “call Xavier.” The mobile phone can process and transcribe the speech request using ASR. The mobile phone can predict one or more text entities corresponding to the speech request. For example, the one or more predicted text entities can include “call Xavier” and “call exam here.” In one embodiment, the mobile phone can predict the text entities based on the pronunciation models for each text entity. In one embodiment, the mobile phone can recognize the “call” command keyword indicating that the speech request is related to communication, likely with a contact in the digital address book of the mobile phone. The mobile phone can prioritize predicted text entities that include contact names over predicted text entities that do not include contact names based on the syntactic context of the speech request. For example, a command to “call exam here” is unlikely to be correct since “exam here” does not correspond to a contact or entity that would reasonably be called. In one embodiment, the prioritization of predicted text entities that include contact names can override acoustic scores or metrics of similarity between pronunciations of the text entity and the speech request.

The mobile phone can select “call Xavier” from the one or more predicted text entities as the outputted text entity. In one embodiment, the mobile phone can display or output an audio confirmation prompt asking if the speech request included a command to “call Xavier.” In one embodiment, the mobile phone can directly initiate a call to a contact named Xavier in the digital address book. The mobile phone can receive a confirmation input in response to the confirmation prompt indicating that the speech request was to call Xavier. In one embodiment, the completion of the call can be a confirmation that the speech request was to call Xavier.

The mobile phone can update the pronunciation model for the named entity Xavier based on the speech request. In one embodiment, the mobile phone can update the pronunciation model to encode or re-encode the pronunciation from the speech request. The mobile phone can further update the pronunciation model based on the one or more predicted text entities that were co-emitted but not output. For example, the text entity “exam here” was co-emitted as an alternative to the named entity Xavier. The outputted text entity and the co-emitted text entity have acoustic similarities in pronunciation, such as the “ex” syllable and the a (long a). The co-emitted text entity can provide an approximation for allowable pronunciations of Xavier. In one embodiment, the mobile phone can compute an area of the phoneme space based on the pronunciations of the co-emitted text entities. For example, the area can be defined by or can include the pronunciation of the co-emitted phrase “exam here.” The mobile phone can use the area to refine or guide encoding of allowable pronunciations of Xavier. In one embodiment, the mobile phone can remove pronunciations that fall outside of the area from the phoneme space for Xavier. For example, the mobile phone can remove pronunciations wherein the X is pronounced as an H. Based on the speech request and the co-emitted text entities, it is not likely that Xavier will be pronounced with an H in the future. In one embodiment, the mobile phone can generate new pronunciations of Xavier based on the pronunciations of the co-emitted text entities (e.g., “exam here”). For example, the new pronunciations can also include an “ex” syllable in order to fall within the area defined by the co-emitted text entities.

Refining the phoneme space based on the co-emitted text entities can be helpful for identifying the named entity Xavier across different audio samples. While the received speech request can provide a single allowable pronunciation of Xavier, it is possible that future audio samples can include slightly different pronunciations. For example, the pronunciation of a word can vary depending on surrounding words in a phrase. The co-emitted text entities, which were predicted based on a measure of confidence, can provide a wider range of accurate and allowable pronunciation data for updating the phoneme space. The mobile phone can update the pronunciation model for Xavier to be specific to a user of the mobile phone. For example, the user of the mobile phone can be more likely to use a first pronunciation of Xavier than a person who speaks a different language. Therefore, the mobile phone can improve recognition of the named entity Xavier for the user to reduce friction in processing speech requests. Advantageously, the mobile phone does not require active input or training from a user outside of typical ASR tasks. The methods and systems presented herein thus provide a zero-added-friction solution for refining a pronunciation model by using pronunciation data provided during ASR.

The above contact and location names are presented herein for illustrative purposes. It can be appreciated that a text entity can include names or words that are not standard or recognized in any language. For example, a device can generate a pronunciation model for a text entity that has been made up by a user of the device and does not have a known definition. In one embodiment, the text entity can include numbers, symbols, emoticons, Unicode encodings, etc. in combination with letters. A device can generate and update pronunciation models for a number of text entities so that each text entity can remain a viable candidate for speech recognition. In this manner, text entities that are similar to each other will not be overwritten or removed from a library of possible text entities for speech recognition. The phoneme space for each text entity can be well-defined and updated based on correction inputs to improve the accuracy of predicted pronunciations and future speech recognition. The methods presented herein for generating and updating pronunciation models and for predicting a pronunciation can be used independently and in combination. For example, a device can generate a pronunciation model for a text entity based on a correction input and can predict a most likely pronunciation for the text entity based on a posterior distribution of pronunciations for the text entity. The device can take steps from one or more methods in combination to improve accuracy of predictions.

Embodiments of the subject matter and the functional operations described in this specification can be implemented by digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus, such as the electronic device, consumer device, networked electronic device, etc. The computer storage medium can be a machine-readable storage device, a machine-readable storage substrate, a random or serial access memory device, or a combination of one or more of them.

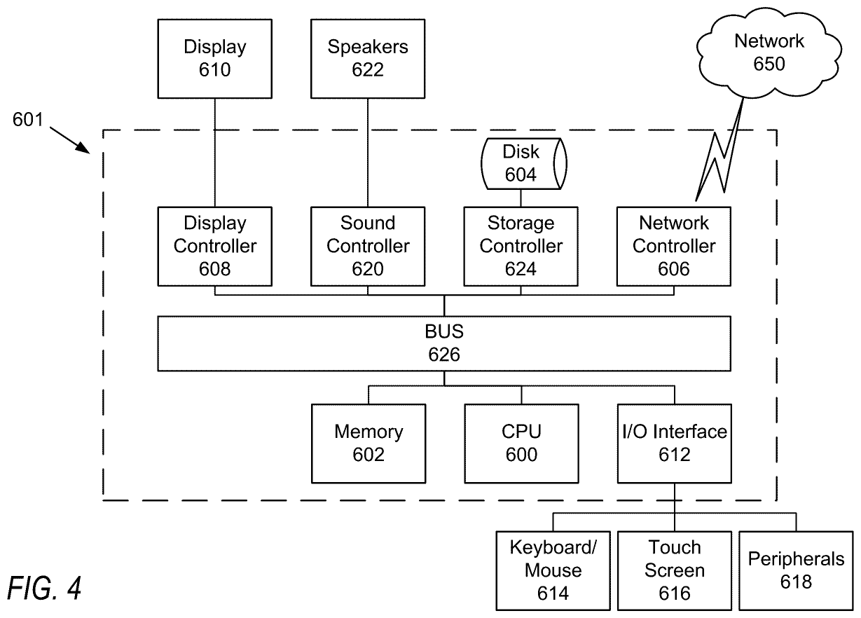

Each of the functions of the described embodiments can be implemented by one or more processing circuits/processing circuitry/processing firmware (may also be referred to as a controller). A processing circuit includes a programmed processor (for example, a CPU of FIG. 4), as a processor includes circuitry. A processing circuit can also include devices such as an application specific integrated circuit (ASIC) and circuit components arranged to perform the recited functions.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, or any other kind of central processing unit. Generally, a CPU will receive instructions and data from a read-only memory or a random access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

Electronic user device 20 shown in FIG. 2 can be an example of one or more of the devices described herein, including an electronic device configured to predict pronunciation of a text entity and a client device configured to record or receive an audio sample. In an embodiment, the electronic user device 20 may be a smartphone. However, the skilled artisan will appreciate that the features described herein may be adapted to be implemented on other devices (e.g., a laptop, a tablet, a server, an e-reader, a camera, a navigation device, etc.). The user device 20 of FIG. 2 includes processing circuitry, as discussed above. The processing circuitry includes one or more of the elements discussed next with reference to FIG. 2. The electronic user device 20 may include other components not explicitly illustrated in FIG. 2 such as a CPU, GPU, frame buffer, etc. The electronic user device 20 includes a controller 410 and a wireless communication processor 402 connected to an antenna 401. A speaker 404 and a microphone 405 are connected to a voice processor 403.

The controller 410 may include one or more processors/processing circuitry (CPU, GPU, or other circuitry) and may control each element in the user device 20 to perform functions related to communication control, audio signal processing, graphics processing, control for the audio signal processing, still and moving image processing and control, and other kinds of signal processing. The controller 410 may perform these functions by executing instructions stored in a memory 450. Alternatively or in addition to the local storage of the memory 450, the functions may be executed using instructions stored on an external device accessed on a network or on a non-transitory computer readable medium.

The memory 450 includes but is not limited to Read Only Memory (ROM), Random Access Memory (RAM), or a memory array including a combination of volatile and non-volatile memory units. The memory 450 may be utilized as working memory by the controller 410 while executing the processes and algorithms of the present disclosure. Additionally, the memory 450 may be used for long-term storage, e.g., of image data and information related thereto.

The user device 20 includes a control line CL and data line DL as internal communication bus lines. Control data to/from the controller 410 may be transmitted through the control line CL. The data line DL may be used for transmission of voice data, displayed data, etc.

The antenna 401 transmits/receives electromagnetic wave signals between base stations for performing radio-based communication, such as the various forms of cellular telephone communication. The wireless communication processor 402 controls the communication performed between the user device 20 and other external devices via the antenna 401. For example, the wireless communication processor 402 may control communication between base stations for cellular phone communication.

The speaker 404 emits an audio signal corresponding to audio data supplied from the voice processor 403. The microphone 405 detects surrounding audio and converts the detected audio into an audio signal. The audio signal may then be output to the voice processor 403 for further processing. The voice processor 403 demodulates and/or decodes the audio data read from the memory 450 or audio data received by the wireless communication processor 402 and/or a short-distance wireless communication processor 407. Additionally, the voice processor 403 may decode audio signals obtained by the microphone 405.

The user device 20 may also include a display 420, a touch panel 430, an operation key 440, and a short-distance communication processor 407 connected to an antenna 406. The display 420 may be a Liquid Crystal Display (LCD), an organic electroluminescence display panel, or another display screen technology. In addition to displaying still and moving image data, the display 420 may display operational inputs, such as numbers or icons which may be used for control of the user device 20. The display 420 may additionally display a GUI for a user to control aspects of the user device 20 and/or other devices. Further, the display 420 may display characters and images received by the user device 20 and/or stored in the memory 450 or accessed from an external device on a network. For example, the user device 20 may access a network such as the Internet and display text and/or images transmitted from a Web server.

The touch panel 430 may include a physical touch panel display screen and a touch panel driver. The touch panel 430 may include one or more touch sensors for detecting an input operation on an operation surface of the touch panel display screen. The touch panel 430 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 430 may detect when the stylus approaches/contacts the operation surface of the touch panel display (similar to the case in which a finger is used for the touch operation).

In certain aspects of the present disclosure, the touch panel 430 may be disposed adjacent to the display 420 (e.g., laminated) or may be formed integrally with the display 420. For simplicity, the present disclosure assumes the touch panel 430 is formed integrally with the display 420 and therefore, examples discussed herein may describe touch operations being performed on the surface of the display 420 rather than the touch panel 430. However, the skilled artisan will appreciate that this is not limiting.

For simplicity, the present disclosure assumes the touch panel 430 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 430 may include transparent electrode touch sensors arranged in the X-Y direction on the surface of transparent sensor glass.

The touch panel driver may be included in the touch panel 430 for control processing related to the touch panel 430, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 430 may detect a position of a user's finger around an edge of the display panel 420 (e.g., gripping a protective case that surrounds the display/touch panel). Signals may be transmitted by the touch panel driver, e.g. in response to a detection of a touch operation, in response to a query from another element based on timed data exchange, etc.

The touch panel 430 and the display 420 may be surrounded by a protective casing, which may also enclose the other elements included in the user device 20. In an embodiment, a position of the user's fingers on the protective casing (but not directly on the surface of the display 420) may be detected by the touch panel 430 sensors. Accordingly, the controller 410 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 410 may be configured to detect which hand is holding the user device 20, based on the detected finger position. For example, the touch panel 430 sensors may detect fingers on the left side of the user device 20 (e.g., on an edge of the display 420 or on the protective casing), and detect a single finger on the right side of the user device 20. In this example, the controller 410 may determine that the user is holding the user device 20 with his/her right hand because the detected grip pattern corresponds to an expected pattern when the user device 20 is held only with the right hand.

The operation key 440 may include one or more buttons or similar external control elements, which may generate an operation signal based on a detected input by the user. In addition to outputs from the touch panel 430, these operation signals may be supplied to the controller 410 for performing related processing and control. In certain aspects of the present disclosure, the processing and/or functions associated with external buttons and the like may be performed by the controller 410 in response to an input operation on the touch panel 430 display screen rather than the external button, key, etc. In this way, external buttons on the user device 20 may be eliminated in lieu of performing inputs via touch operations, thereby improving watertightness.

The antenna 406 may transmit/receive electromagnetic wave signals to/from other external apparatuses, and the short-distance wireless communication processor 407 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 407.

The user device 20 may include a motion sensor 408. The motion sensor 408 may detect features of motion (i.e., one or more movements) of the user device 20. For example, the motion sensor 408 may include an accelerometer to detect acceleration, a gyroscope to detect angular velocity, a geomagnetic sensor to detect direction, a geo-location sensor to detect location, etc., or a combination thereof to detect motion of the user device 20. In an embodiment, the motion sensor 408 may generate a detection signal that includes data representing the detected motion. For example, the motion sensor 408 may determine a number of distinct movements in a motion (e.g., from start of the series of movements to the stop, within a predetermined time interval, etc.), a number of physical shocks on the user device 20 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 410, whereby further processing may be performed based on data included in the detection signal. The motion sensor 408 can work in conjunction with a Global Positioning System (GPS) section 460. The information of the present position detected by the GPS section 460 is transmitted to the controller 410. An antenna 461 is connected to the GPS section 460 for receiving and transmitting signals to and from a GPS satellite.

The user device 20 may include a camera section 409, which includes a lens and shutter for capturing photographs of the surroundings around the user device 20. In an embodiment, the camera section 409 captures surroundings of an opposite side of the user device 20 from the user. The images of the captured photographs can be displayed on the display panel 420. A memory section saves the captured photographs. The memory section may reside within the camera section 109 or it may be part of the memory 450. The camera section 409 can be a separate feature attached to the user device 20 or it can be a built-in camera feature.

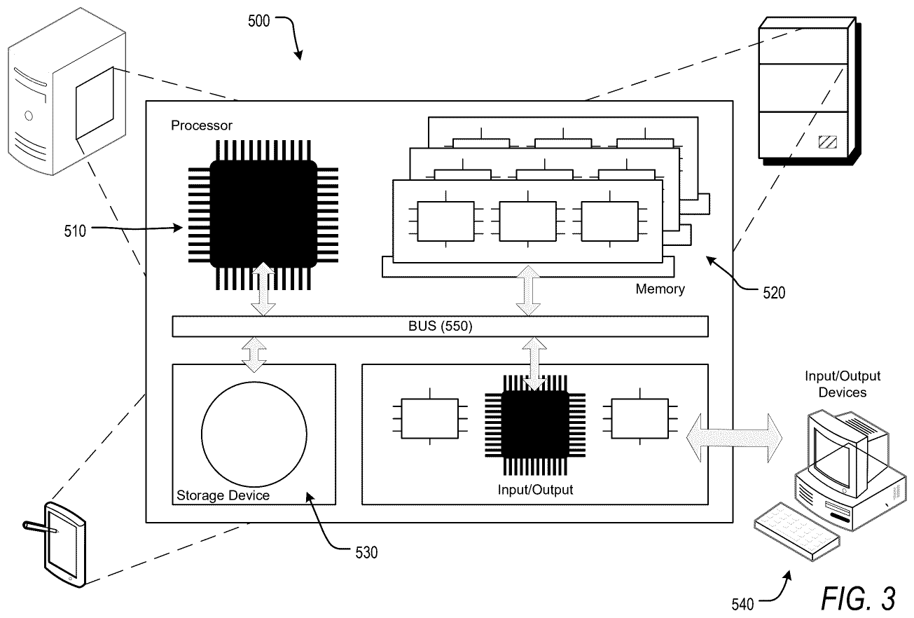

An example of a type of computer is shown in FIG. 3. The computer 500 can be used for the operations described in association with any of the computer-implement methods described previously, according to one implementation. For example, the computer 500 can be an example of an electronic device, such as a computer or mobile device, or a networked device such as a server. The processing circuitry includes one or more of the elements discussed next with reference to FIG. 3. In FIG. 3, the computer 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the computer 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the computer 500. In one implementation, the storage device 530 is a computer-readable medium. In various different implementations, the storage device 530 may be a floppy disk device, a hard disk device, an optical disk device, or a tape device.

The input/output device 540 provides input/output operations for the computer 500. In one implementation, the input/output device 540 includes a keyboard and/or pointing device. In another implementation, the input/output device 540 includes a display unit for displaying graphical user interfaces.

Next, a hardware description of a device 601 according to the present embodiments is described with reference to FIG. 4. In FIG. 4, the device 601, which can be any of the above described devices, including the electronic devices and the networked devices, includes processing circuitry. The processing circuitry includes one or more of the elements discussed next with reference to FIG. 4. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above.

The device 601 in FIG. 4 also includes a network controller 606, such as an Intel Ethernet PRO network interface card from Intel Corporation of America, for interfacing with network 650. and to communicate with the other devices. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 601 further includes a display controller 608, such as a NVIDIA Geforce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners.

A sound controller 620 is also provided in the device 601 to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Embodiments of the present disclosure may also be set forth in the following parentheticals.
(1) A method for predicting pronunciation of a text sample, comprising generating, via processing circuitry, an encoding of allowable pronunciations of the text sample; selecting, via the processing circuitry, predicted text samples corresponding to an audio sample, the predicted text samples including the text sample and one or more co-emitted text samples; outputting, via the processing circuitry, the text sample; and updating, via the processing circuitry, the encoding of allowable pronunciations of the text sample based on pronunciations of the one or more co-emitted text samples.
(2) The method of (1), wherein the encoding of allowable pronunciations is generated based on a measure of pronunciation certainty of the text sample.
(3) The method of (1) to (2), wherein the text sample is outputted based on syntactic context of the audio sample.
(4) The method of (1) to (3), wherein the updating the encoding of allowable pronunciations of the text sample includes computing an intersection set of the pronunciations of the one or more co-emitted text samples in the encoding of allowable pronunciations of the text sample.
(5) The method of (1) to (4), wherein the updating the encoding of allowable pronunciations of the text sample includes updating a predicted accuracy of allowable pronunciations of the text sample based on the pronunciations of the one or more co-emitted text samples.
(6) The method of (1) to (5), wherein the updating the encoding of allowable pronunciations of the text sample includes generating allowable pronunciations using a graphene-to-phoneme model.
(7) The method of (1) to (6), wherein the pronunciations of the one or more co-emitted text samples are inputs to the graphene-to-phoneme model.
(8) A device comprising processing circuitry configured to generate an encoding of allowable pronunciations of a text sample, select predicted text samples corresponding to an audio sample, the predicted text samples including the text sample and one or more co-emitted text samples, output the text sample, and update the encoding of allowable pronunciations of the text sample based on pronunciations of the one or more co-emitted text samples.
(9) The device of (8), wherein the encoding of allowable pronunciations is generated based on a measure of pronunciation certainty of the text sample.
(10) The device of (8) to (9), wherein the text sample is outputted based on syntactic context of the audio sample.
(11) The device of (8) to (10), wherein the processing circuitry is configured to update the encoding of allowable pronunciations of the text sample by computing an intersection set of the pronunciations of the one or more co-emitted text samples in the encoding of allowable pronunciations of the text sample.
(12) The device of (8) to (11), wherein the processing circuitry is configured to update the encoding of allowable pronunciations of the text sample by updating a predicted accuracy of allowable pronunciations of the text sample based on the pronunciations of the one or more co-emitted text samples.
(13) The device of (8) to (12), wherein the processing circuitry is configured to update the encoding of allowable pronunciations of the text sample by generating allowable pronunciations using a graphene-to-phoneme model.
(14) A non-transitory computer-readable storage medium for storing computer-readable instructions that, when executed by a computer, cause the computer to perform a method, the method comprising: generating an encoding of allowable pronunciations of a text sample; selecting predicted text samples corresponding to an audio sample, the predicted text samples including the text sample and one or more co-emitted text samples; outputting the text sample; and updating the encoding of allowable pronunciations of the text sample based on pronunciations of the one or more co-emitted text samples.
(15) The non-transitory computer-readable storage medium of (14), wherein the encoding of allowable pronunciations is generated based on a measure of pronunciation certainty of the text sample.
(16) The non-transitory computer-readable storage medium of (14) to (15), wherein the text sample is outputted based on syntactic context of the audio sample.
(17) The non-transitory computer-readable storage medium of (14) to (16), wherein the updating the encoding of allowable pronunciations of the text sample includes computing an intersection set of the pronunciations of the one or more co-emitted text samples in the encoding of allowable pronunciations of the text sample.
(18) The non-transitory computer-readable storage medium of (14) to (17), wherein the updating the encoding of allowable pronunciations of the text sample includes updating a predicted accuracy of allowable pronunciations of the text sample based on the pronunciations of the one or more co-emitted text samples.
(19) The non-transitory computer-readable storage medium of (14) to (18), wherein the updating the encoding of allowable pronunciations of the text sample includes generating allowable pronunciations using a graphene-to-phoneme model.
(20) The non-transitory computer-readable storage medium of (14) to (19), wherein the pronunciations of the one or more co-emitted text samples are inputs to the graphene-to-phoneme model.

Thus, the foregoing discussion discloses and describes merely example embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A method for predicting pronunciation of a text sample, comprising:
generating, via processing circuitry, an encoding of allowable pronunciations of the text sample;
selecting, via the processing circuitry, predicted text samples corresponding to an audio sample, the predicted text samples including the text sample and one or more co-emitted text samples;
outputting, via the processing circuitry, the text sample; and
updating, via the processing circuitry, the encoding of allowable pronunciations of the text sample based on pronunciations of the one or more co-emitted text samples.

2. The method of claim 1, wherein the encoding of allowable pronunciations is generated based on a measure of pronunciation certainty of the text sample.

3. The method of claim 1, wherein the text sample is outputted based on syntactic context of the audio sample.

4. The method of claim 1, wherein the updating the encoding of allowable pronunciations of the text sample includes computing an intersection set of the pronunciations of the one or more co-emitted text samples in the encoding of allowable pronunciations of the text sample.

5. The method of claim 1, wherein the updating the encoding of allowable pronunciations of the text sample includes updating a predicted accuracy of allowable pronunciations of the text sample based on the pronunciations of the one or more co-emitted text samples.

6. The method of claim 1, wherein the updating the encoding of allowable pronunciations of the text sample includes generating allowable pronunciations using a graphene-to-phoneme model.

7. The method of claim 6, wherein the pronunciations of the one or more co-emitted text samples are inputs to the graphene-to-phoneme model.

8. A device comprising:
processing circuitry configured to
generate an encoding of allowable pronunciations of a text sample,
select predicted text samples corresponding to an audio sample, the predicted text samples including the text sample and one or more co-emitted text samples,
output the text sample, and
update the encoding of allowable pronunciations of the text sample based on pronunciations of the one or more co-emitted text samples.

9. The device of claim 8, wherein the encoding of allowable pronunciations is generated based on a measure of pronunciation certainty of the text sample.

10. The device of claim 8, wherein the text sample is outputted based on syntactic context of the audio sample.

11. The device of claim 8, wherein the processing circuitry is configured to update the encoding of allowable pronunciations of the text sample by computing an intersection set of the pronunciations of the one or more co-emitted text samples in the encoding of allowable pronunciations of the text sample.

12. The device of claim 8, wherein the processing circuitry is configured to update the encoding of allowable pronunciations of the text sample by updating a predicted accuracy of allowable pronunciations of the text sample based on the pronunciations of the one or more co-emitted text samples.

13. The device of claim 8, wherein the processing circuitry is configured to update the encoding of allowable pronunciations of the text sample by generating allowable pronunciations using a graphene-to-phoneme model.

14. A non-transitory computer-readable storage medium for storing computer-readable instructions that, when executed by a computer, cause the computer to perform a method, the method comprising:
generating an encoding of allowable pronunciations of a text sample;
selecting predicted text samples corresponding to an audio sample, the predicted text samples including the text sample and one or more co-emitted text samples;
outputting the text sample; and
updating the encoding of allowable pronunciations of the text sample based on pronunciations of the one or more co-emitted text samples.

15. The non-transitory computer-readable storage medium of claim 14, wherein the encoding of allowable pronunciations is generated based on a measure of pronunciation certainty of the text sample.

16. The non-transitory computer-readable storage medium of claim 14, wherein the text sample is outputted based on syntactic context of the audio sample.

17. The non-transitory computer-readable storage medium of claim 14, wherein the updating the encoding of allowable pronunciations of the text sample includes computing an intersection set of the pronunciations of the one or more co-emitted text samples in the encoding of allowable pronunciations of the text sample.

18. The non-transitory computer-readable storage medium of claim 14, wherein the updating the encoding of allowable pronunciations of the text sample includes updating a predicted accuracy of allowable pronunciations of the text sample based on the pronunciations of the one or more co-emitted text samples.

19. The non-transitory computer-readable storage medium of claim 14, wherein the updating the encoding of allowable pronunciations of the text sample includes generating allowable pronunciations using a graphene-to-phoneme model.

20. The non-transitory computer-readable storage medium of claim 19, wherein the pronunciations of the one or more co-emitted text samples are inputs to the graphene-to-phoneme model.
